(19) United States
(12) Patent Application Publication
(10) Pub. No.: US 2014/0095294 A1
(43) Pub. Date: Apr. 3, 2014

(54) MECHANISM FOR FACILITATING CONTEXT-AWARE BROADCAST AND VIRTUAL VISUALIZATION OF ADVERTISEMENTS

(71) Applicants: CORNELIUS V. VICK, Sacramento, CA (US); Eddie Balthasar, Folsom, CA (US); Richard T. Beckwith, Portland, OR (US)

(72) Inventors: CORNELIUS V. VICK, Sacramento, CA (US); Eddie Balthasar, Folsom, CA (US); Richard T. Beckwith, Portland, OR (US)

(21) Appl. No.: 13/630,289

(22) Filed: Sep. 28, 2012

(51) Int. Cl. G06Q 30/02

(52) U.S. Cl. 705/14.43; 705/14.49; 705/14.62

(57) ABSTRACT

A mechanism is described for facilitating context-aware broadcast and virtual visualization of advertisements according to one embodiment. A method of embodiments, as described herein, includes evaluating, via data management logic, context-aware data, and recommending, via advertisement recommendation logic, a context-aware advertisement based the evaluation of the context-aware data, and wherein the recommended context-aware advertisement is placed via at least one of a radio of a vehicle or a computing device within a proximity of the vehicle, wherein the computing device includes a mobile computing device. Other embodiments are described and claimed.

### FIELD

Embodiments disclosed herein relate to messaging systems. More particularly, embodiments relate to a mechanism for facilitating context-aware broadcast and virtual visualization of advertisements.

### BACKGROUND

Even with increasing traffic and technologically-advanced vehicles, conventional techniques to provide advertisements in vehicles are very limited in their approach and mostly-wasted. For example, using conventional techniques, most advertisements in a vehicle are provided through a radio or a global positioning system (GPS)-based navigation system.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a context-aware advertisement delivery mechanism employed at a computing device according to one embodiment.

FIG. 2 illustrates a context-aware advertisement delivery mechanism and a vehicle-based advertisement broadcast mechanism according to one embodiment.

FIG. 3 illustrates a method for facilitating delivery and placement of a context-aware advertisement according to one embodiment.

FIG. 4A illustrates a context-aware advertisement delivery mechanism and a vehicle-based virtual advertisement visualization mechanism according to one embodiment.

FIG. 4B illustrates a virtually displayed advertisement according to one embodiment.

FIG. 5 illustrates a method for facilitating delivery and display of a virtual advertisement according to one embodiment.

FIG. 6 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments facilitate delivery of context-aware advertisement for vehicles, such that the advertisements are based on real-time context (such as playing an advertisement recommending a nearby gas station when the car is found low on gasoline, etc.). In one embodiments, context-aware advertisements are specific to any number and type of factors including, but not limited to, condition of the vehicle (e.g., low on gas, need new brakes, etc.), location of the vehicle (e.g., near an amusement park, near a grocery store, stuck in traffic on a freeway, a particular city or town, etc.), environmental conditions (e.g., rain, snow, road conditions (e.g., constructions, accident, etc.), potholes, etc.), condition of expected listeners (e.g., at lunch time, so the driver and/or passengers might be hungry, at a play or ballgame, so the driver and/or the passengers might be interested in a nearby parking lot or restaurant, etc.), or the like. Embodiments further provide virtual delivery and visualization of external/outdoor advertisement and/or announcements at a portion of a windshield of a vehicle. External/outdoor advertisement/announcement may be obtained from structures or sources external to the vehicle, such as, but not limited to, standalone billboards, building/structure-based billboards, regular billboards, electronic billboards, painted billboards, inflatable billboards, etc.

For example, today's cars are a good source of context data, such as a car with a navigation system can provide the exact location of the car, while various sensors in the car can detect and indicate a number of factors relating to the car, such as the car's fuel level and mileage of the car, while the driver's (or passenger's) personal device (e.g., mobile computing device, such as a Bluetooth-paired smartphone) can pair up with the car's hands-free system to indicate the identity and preferences of the persons in the car. In one embodiment, context data may be combined with the user profile as targeted by terrestrial, satellite, and/or Internet radio services to provide recommended context-aware advertisements. For example, a car that is low on fuel may be targeted with an advertisement for a nearby gas station, while, similarly, the age and interests of the persons in the car may be used to recommend and play an advertisement relating to a hair salon.

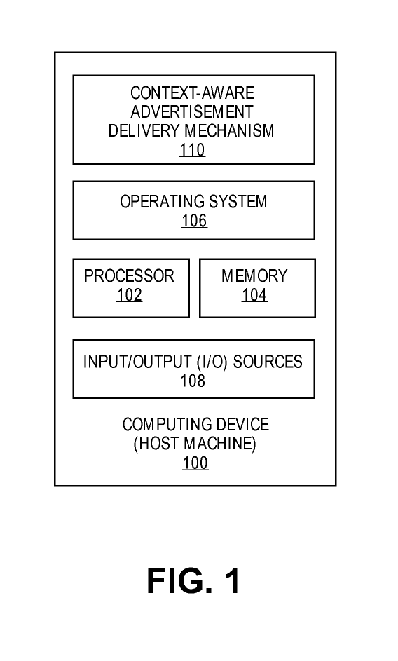

FIG. 1 illustrates a context-aware advertisement delivery mechanism 110 employed at a computing device 100 according to one embodiment. Computing device 100 serves as a host machine to employ context-aware advertisement delivery mechanism (“delivery mechanism”) 110 to facilitate delivery of context-aware advertisements for vehicles (e.g., any motorcycle or automobiles having a radio, such as cars, trucks, sports utility vehicles (SUV), etc.). Computing device 100 may include mobile computing devices, such as cellular phones including smartphones (e.g., iPhone® by Apple®, BlackBerry® by Research in Motion®, etc.), personal digital assistants (PDAs), etc., tablet computers (e.g., iPad® by Apple®, Galaxy 3® by Samsung®, etc.), laptop computers (e.g., notebook, netbook, ultrabook™, etc.), e-readers (e.g., Kindle® by Amazon®, Nook® by Barnes and Nobles®, etc.), etc. Computing device 100 may further include set-top boxes (e.g., Internet-based cable television set-top boxes, etc.), and larger computing devices, such as desktop computers, server computers, etc.

Computing device 100 includes an operating system (OS) 106 serving as an interface between any hardware or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “computing device”, “node”, “computing node”, “client”, “host”, “server”, “memory server”, “machine”, “device”, “computing device”, “computer”, “computing system”, and the like, may be used interchangeably throughout this document.

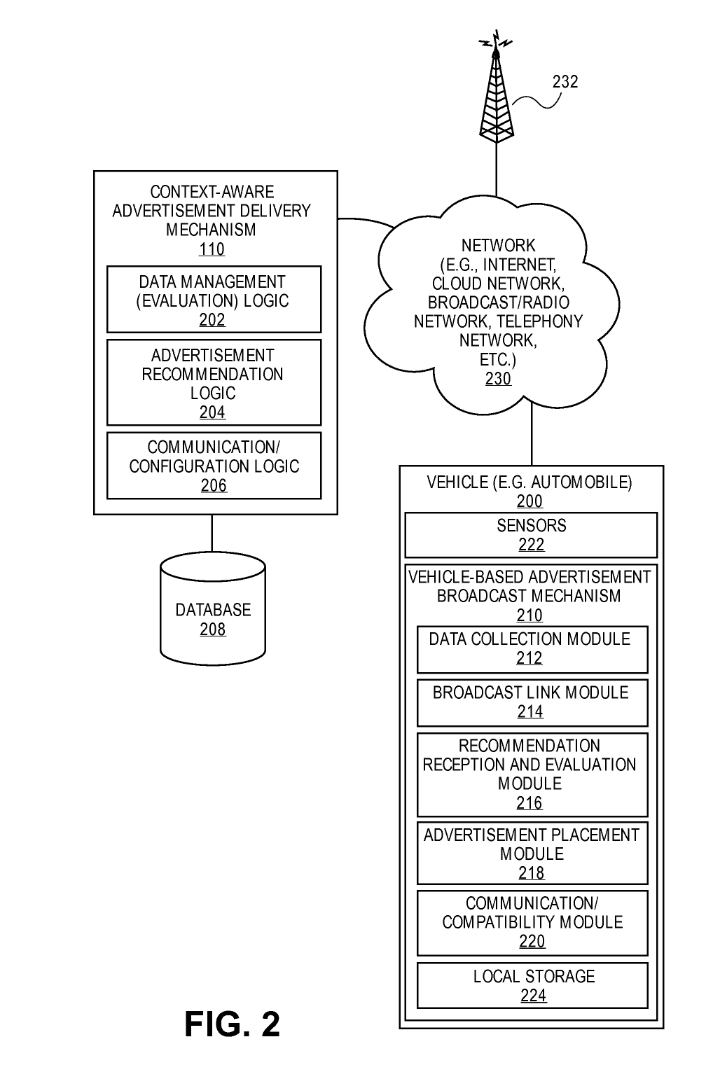

FIG. 2 illustrates a context-aware advertisement delivery mechanism 110 and a vehicle-based advertisement broadcast mechanism 210 according to one embodiment. In one embodiment, delivery mechanism 110 includes a number of components, such as data management (evaluation) logic 202, advertisement recommendation logic 204, and communication/configuration logic 206, and is in communication with database 208. Similarly, vehicle-based advertisement broadcast mechanism (“broadcast mechanism”) 210 includes a number of components, such as data collection module 212, broadcast link module 214, recommendation reception and evaluation module 216, advertisement placement module 218, and communication/compatibility module 220. Throughout this document, the term “logic” may be interchangeably referred to as “component” or “module” and may include, by way of example, software, hardware, and/or any combination of software and hardware, such as firmware.

Vehicle 200 may have sensors 222 (e.g., GPS, brake sensors, rain sensors, fuel sensors, temperature sensors, oxygen sensors, parking sensors, compasses, speedometers, clocks, on-board diagnostics (OBD) tools, etc.) to detect real-time data about the vehicle 200 and the surrounding environment. Vehicle 200 may employ or recognize other devices (e.g., Bluetooth- pair devices, such as smartphones) to provide a clear picture of the current status of the vehicle 200, its location, and identification and preferences of the persons in the vehicle 200, etc. Vehicle 200 may also have an on-board computer to process any results obtained from those sensors 222 to contribute towards better performance of the vehicle 200. In one embodiment, broadcast mechanism 210 may be employed as a software application at the on-board computer of vehicle 200 and be in communication with sensors 222. For example and in one embodiment, data collection module 212 of broadcast mechanism 210 communicates with sensors 222 to obtain context data sensed by one or more of sensors 222. For example, a gas sensor of sensors 222 may have already sensed the vehicle 200 is low on gas, a clock at the vehicle 200 may indicate the current time (e.g., noon), while a GPS/navigation system of the vehicle 200 may point to the currently geographic location of the vehicle 200.

Having obtained these pieces of data from sensors 222, data collection module may provide the collected data to data management (evaluation) logic 202 at delivery mechanism 110 over network 230. Data management logic 202 may evaluate the received data based on the information received and other relevant information (e.g., information relating to known restaurants, service stations, etc.) stored at database 208 and then provides the results or evaluated data to advertisement recommendation logic 204 so proper advertisements may be recommended to broadcast mechanism 210. In one embodiment, broadcast mechanism 210 may be in communication with a vehicle-based database (not shown) to serve as a persistent local storage system 224 to store any number and type of recommended advertisements locally at vehicle 200.

In one embodiment, radio station 232 (e.g., terrestrial or satellite) may maintain communication with broadcast link module 214 (e.g., terrestrial or satellite radio) at broadcast mechanism 210 and advertisement recommendation logic 204 at delivery mechanism 110. However, in one embodiment, when advertisement recommendation logic 204 recommends a new context-aware advertisement, it sends a message to radio station 232 indicating a recommendation of a context-aware (“non-broadcast”) advertisement has been sent to broadcast mechanism 210. A broadcast stream (e.g., an audio stream) may be received at broadcast link module 214 from broadcast/radio station 232 such that the broadcast stream may have one or more embedded signals to indicate that an advertisement insertion may be desired. For example, a signal may provide information about the time, length and advertisement context criteria to replace one or more broadcast advertisements with one or more recommended context aware advertisements that are retrieved from a local storage device at the vehicle. In one embodiment, upon evaluation of the signals received via a broadcast stream, one or more broadcast(ed) advertisements are then replaced with one or more context-aware advertisements

Upon receiving the recommended advertisement at recommendation reception and evaluation module 216, the recommended advertisement is evaluated in light of the most recent data received from sensors 222 (e.g., to check whether the recommended advertisement is still relevant, such as whether a certain gas station to which the advertisement relates is still within a reasonable distance of vehicle 200, etc.) and if approved, is forwarded on to advertisement placement module 218. Further upon approve of the recommended advertisement, broadcast link module 214 may communicate with radio station 232 to indicate the approval and potential placement of the recommended advertisement (and, in other words, confirming the previous warning to radio station 232 by advertisement recommendation logic 204. Upon receiving the indication or notice, radio station 232 may temporarily stop any broadcast programming so that advertisement placement module 218 may take advantage of the empty block of radio/broadcast time to facilitate placement of the recommended advertisement in that slot on the radio of vehicle 200.

Further, when the recommendation advertisement is broadcasted or played on the vehicle radio, an advertisement insertion code may be embedded in the audio stream of the recommended advertisement. The embedded insertion code may contain certain specifics about the type of advertisement and context to consider for insertion. The car radio may use the insertion code and any input from data collection module 212 to select and advertisement from the persistent advertisement storage system 224 and begin to play the advertisement in lieu of the broadcasted advertisement. Broadcast mechanism 210 may record the delivery of the broadcasted recommendation advertisements and periodically, further statistics can be obtained and uploaded to radio station 232 for future use. In one embodiment, the statistics may be collected and stored at persistent local storage 224 and/or update to broadcast/radio station 232. The future use may include recommending and/or broadcasting future advertisements based on the acquired or obtained statistics such that the advertisements are automatically adjusted according to the statistics. Further, the statistics may be collected on-demand and/or periodically as predetermined or pre-defined as desired or necessitated.

Regarding advertisement recommendations, continuing with the aforementioned data collected by the gas sensor, the clock, and the GPS, multiple recommended advertisements may be provided and placed, such as an advertisement regarding a nearby gas station to fill up the nearly empty gas tank and another advertisement regarding a restaurant for lunch given the clock indicates noon and lunch time, and the like.

Communication/configuration logic 206 and communication/configuration module 220 may facilitate the ability to communicate with various other vehicles, radio stations, networks, computing devices (e.g., mobile computing devices (such as various types of smartphones, tablet computers), websites, (such as social networking websites (e.g., Facebook®, LinkedIn®, Google+®, etc.)), other networks, etc.), while ensuring compatibility with changing technologies, parameters, protocols, standards, etc. Communication/configuration module 220 may be used to download any recommendation advertisements to the persistent local storage 224 at vehicle 200 and update statistics about a variety of impressions relating to the stored advertisements. For example, the download may occur over a network, such as a satellite network, a cellular network, or a particular frequency in the radio spectrum, such as a radio station 232 that broadcasts advertisements and its tags.

It is contemplated that any number and type of components may be added to and/or removed from delivery mechanism 110 and/or broadcast mechanism 210 to facilitate various embodiments including adding, removing, and/or enhancing certain features. For brevity, clarity, and ease of understanding of the delivery and broadcast mechanisms 110, 210 many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

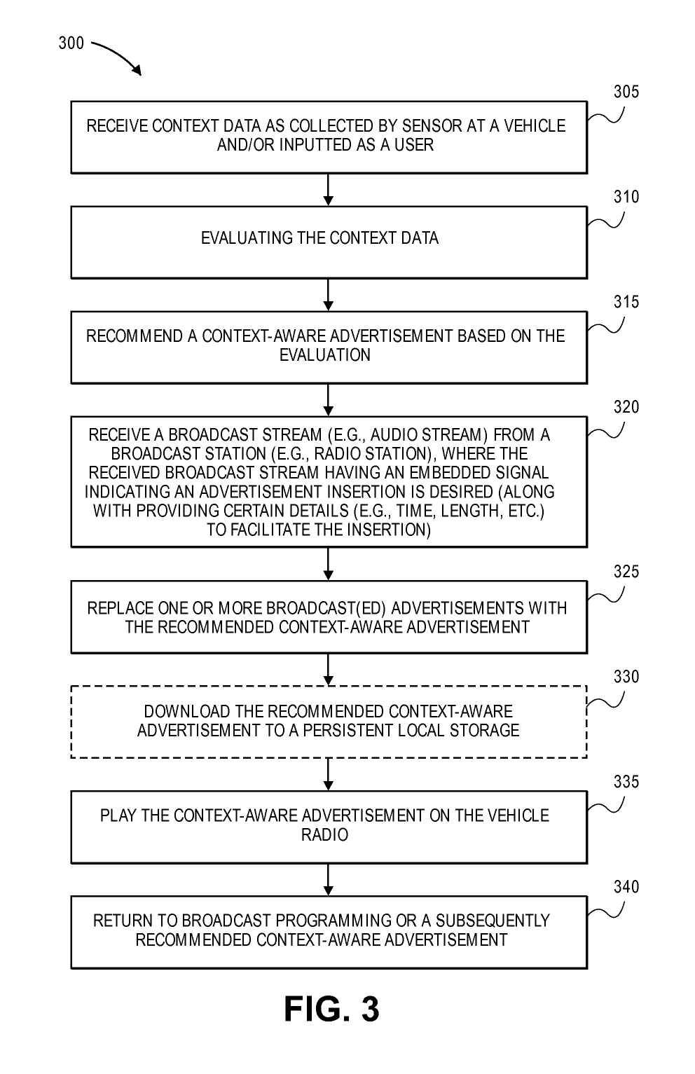

FIG. 3 illustrates a method for facilitating delivery and placement of a context-aware advertisement according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by delivery mechanism 110 of FIG. 1 and/or broadcast mechanism 210 of FIG. 2.

Method 300 begins at block 305 with context data relating to a vehicle and/or its surrounding environment is collected by one or more sensors at the vehicle and/or as inputted by a user (e.g., a driver/owner of the vehicle inputting destination information in the vehicle's GPS/navigation system). At block 310, the collected context data is the evaluated to potentially recommend a context-aware advertisement. At block 315, a context-aware advertisement is recommended based on the evaluated context data. At block 320, a broadcast stream (e.g., an audio stream) is received from a broadcast station (e.g., radio station), where the broadcast stream may have embedded signals to indicate that an advertisement insertion is desired. For example, a signal may provide information about the time, length and advertisement context criteria to replace one or more broadcast advertisements with one or more recommended context aware advertisements that are retrieved from a local storage device at the vehicle. At block 325, in one embodiment, upon evaluation of the signals received via a broadcast stream, one or more broadcast advertisements are then replaced with one or more context-aware advertisements. Optionally, in one embodiment, at block 330, the recommended context-aware advertisements may be stored at a persistent local storage of a vehicle, such as persistent local storage 224 of FIG. 2.

At block 335, the context-aware advertisement is played on the vehicle radio using the available airspace. At block 340, once the context-aware advertisement has ended or played out (e.g., in some cases, it may be repeated multiple times), the radio broadcast returns to playing the broadcast programming or subsequent context-aware advertisement (if, in the meantime, additional context-aware advertisement is recommended).

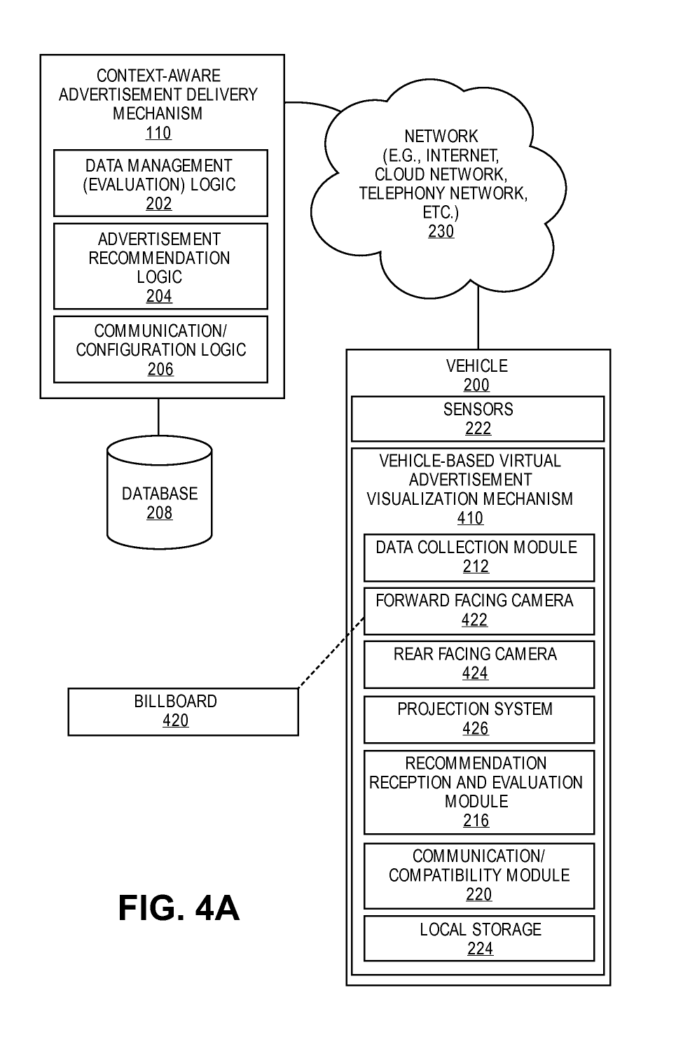

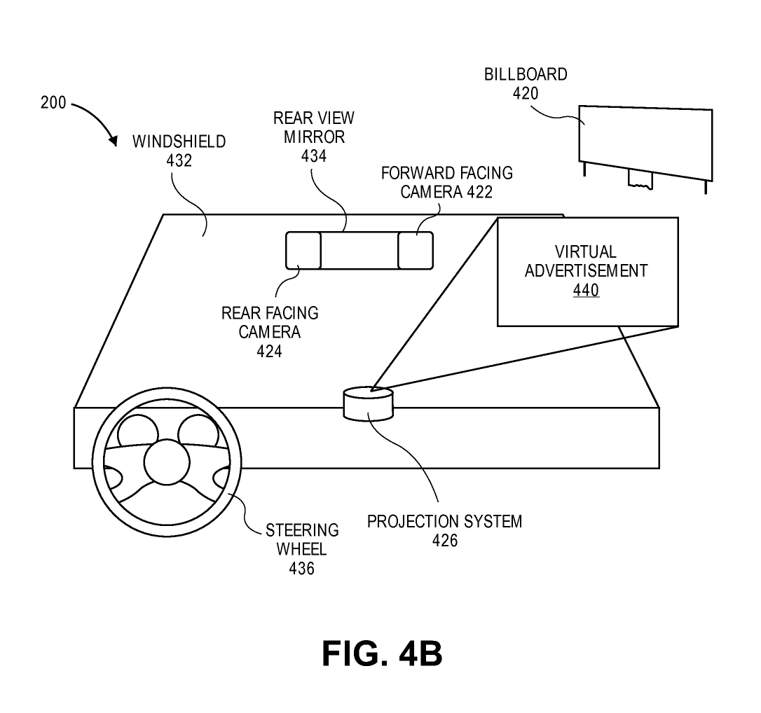

FIG. 4A illustrates a context-aware advertisement delivery mechanism 110 and a vehicle-based virtual advertisement visualization mechanism 410 according to one embodiment. It is to be noted that for brevity, clarity, and ease of understanding, some of the components and functionalities discussed with reference to FIG. 2 are not repeated here. In one embodiment, vehicle-based virtual advertisement visualization mechanism (“visualization mechanism) 410 may be employed at an onboard computer of vehicle 200 and include a number of components, such as data collection module 212, recommendation reception and evaluation logic 216, communication/compatibility logic 220, local storage 224, forward facing camera 422, rear facing camera 424, and projection system 426. In one embodiment, an image of an advertisement or announcement displayed on an external structure or source 420 (e.g., external/outdoor advertisement/announcement structures or sources, such as, but not limited to, standalone billboards, building/structure-based billboards, regular billboards, electronic billboards, painted billboards, inflatable billboards, etc.) may be obtained and then displayed on a section or portion of a windshield of vehicle 200 depending on a driver's and/or a passenger's eye movement, as is illustrated with reference to FIG. 4B. In some embodiment, one or more context-aware advertisements (as discussed with reference to FIG. 2) may be displayed on a section or portion of the windshield of vehicle 200 when billboard 420 is blank. In some embodiment, one or more context-aware advertisements (as discussed with reference to FIG. 2) may be displayed on a section or portion of the windshield of vehicle 200 irrelevant of whether a billboard 420 is encountered or whether is blank.

In one embodiment, forward facing camera 422 captures the advertisement image on an upcoming external source (e.g., billboard) 420 as vehicle 200 drives towards it, while, inside the vehicle 200, rear facing camera 424 tracks the driver's eyes to determine where on the windshield to display the billboard advertisement so it is properly seen by the driver. In one embodiment, per the driver's profile, as the driver's eyes move in various directions, the displayed advertisement moves parallel to it so that the advertisement can be seen and tracked by the driver. In another embodiment, per the driver's profile, the advertisement may be fixed in the original spot of the windshield where it is displayed and remains there so, for example, the driver may choose to ignore the advertisement. Tracking data collected by forward facing and rear facing cameras 422, 424 is provided to recommendation reception and evaluation module 216 for processing while simultaneously considering any context-aware advertisement recommendations from delivery mechanism 110. Upon evaluation and if no relevant context-aware advertisement is received, in one embodiment, the billboard advertisement is provided to projection system 426 to virtually display it on a portion of the windshield corresponding to the driver's eyes. In another embodiment, if billboard is blank and/or a pertinent recommendation for a context-aware advertisement (e.g., advertising a nearby gas station when the vehicle's gas tank is nearly empty), the recommended context-aware advertisement may be virtually displayed on the windshield by projection system 426.

It is contemplated that any number and type of components may be added to and/or removed from delivery mechanism 110 and/or visualization mechanism 410 to facilitate various embodiments including adding, removing, and/or enhancing certain features. For brevity, clarity, and ease of understanding of the delivery and visualization mechanisms 110, 410 many of the standard and/or known components, such as those of a computing device, are not shown or discussed here. It is contemplated that embodiments are not limited to any particular technology, topology, system, architecture, and/or standard and are dynamic enough to adopt and adapt to any future changes.

FIG. 4B illustrates a virtually displayed advertisement 440 according to one embodiment. In one embodiment, as discussed with referenced to FIG. 4B, a virtual advertisement 440 is displayed on the windshield 432 of a vehicle 200. Further, in one embodiment, the vehicle 200 employs a forward facing camera 422, a rear facing camera 424, a projection system 426 as referenced with regard to FIG. 4A. In the illustrated embodiment, the virtual advertisement 440 is the same as the advertisement shown on an external source (e.g., billboard) 420 that is down the road from the current position of the vehicle 200. The vehicle 200 may include other components and devices, such as a steering wheel 436, a rear-view minor 434, and the like. It is contemplated that embodiments are not limited to the exact locations of components and/or devices illustrated here (such as the locations of the two cameras 422, 424) and that any of these locations may be altered or exchanged as desired or necessitated.

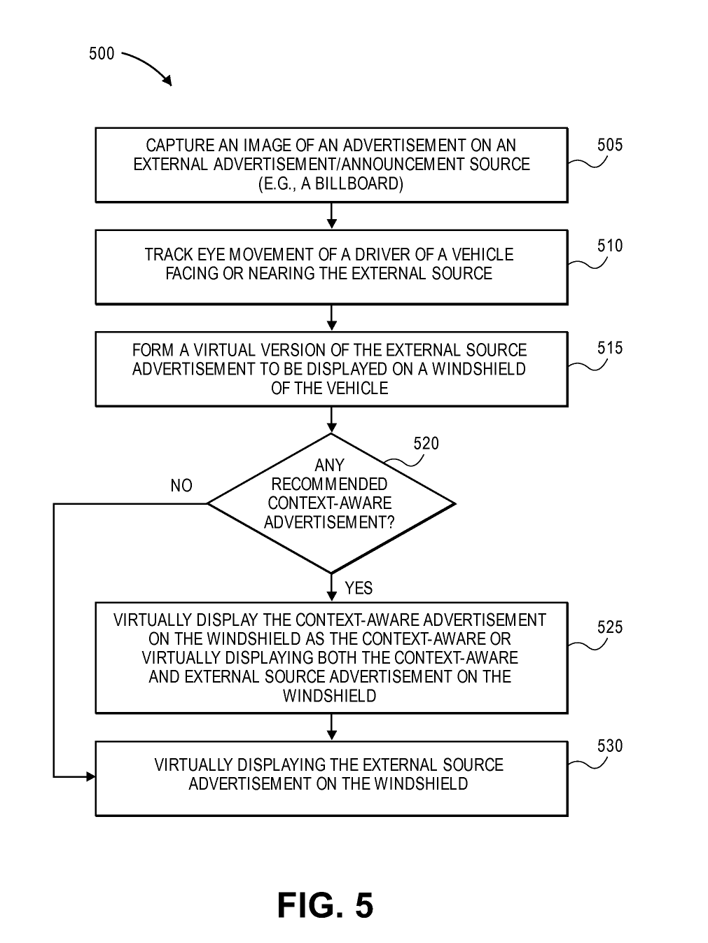

FIG. 5 illustrates a method for facilitating delivery and display of a virtual advertisement according to one embodiment. Method 500 may be performed by processing logic that may comprise hardware (e.g., circuitry, dedicated logic, programmable logic, etc.), software (such as instructions run on a processing device), or a combination thereof. In one embodiment, method 300 may be performed by delivery mechanism 110 of FIG. 1 and/or visualization mechanism 410 of FIG. 4A.

Method 500 begins at block 505 with a forward facing camera in a vehicle capturing an image of an advertisement or announcement on an external source or an outdoor structure, such as a billboard. The billboard may be sighted by the forward facing camera as the vehicle may be approaching the billboard or simply facing it or parked in front of it. Similarly, at block 510, the rear facing camera of the vehicle tracks the eye movement of the driver of the vehicle. In some embodiments, eye movements of one or more passengers may be tracked in addition to or instead of tracking the driver's eye movement. At block 515, based on the obtained relating to the captured billboard advertisement image and the driver's eye movement, a virtual version of the billboard advertisement is formed to be subsequently displayed on a portion of a windshield of the vehicle. The portion may be determined and selected based on the tracking data relating to the eye movement as obtained by the rear facing camera.

At block 520, a determination is made as to whether there are any context-aware advertisements recommended to be virtually displayed. At block 525, if there is a recommended context-aware advertisement to be displayed, in one embodiment, the recommended context-aware advertisements supersedes the virtual billboard advertisement and is virtually displayed on a portion of the windshield as determined from using the eye movement-related data. In another embodiment, both the context-aware and billboard advertisements may be simultaneously virtually displayed on the windshield so that both advertisements can be seen by the driver and/or passenger(s), such as in two different portions or sections of the windshield as determined from using the eye movement-related data. In yet another embodiment, the context-aware and billboard advertisements may be alternatively displayed in a single section of the windshield so that both advertisements can be alternatively seen (by the driver and/or passenger(s)) in the single section as determined from using the eye movement-related data. Referring back to block 525, if there are no recommended context-aware advertisements to be displayed, at block 530, in one embodiment, the billboard advertisement is virtually displayed using a portion of the windshield as determined from using the eye movement-related data. In one embodiment, the billboard advertisement may be virtually displayed after having displayed any recommended context-aware advertisement on the windshield.

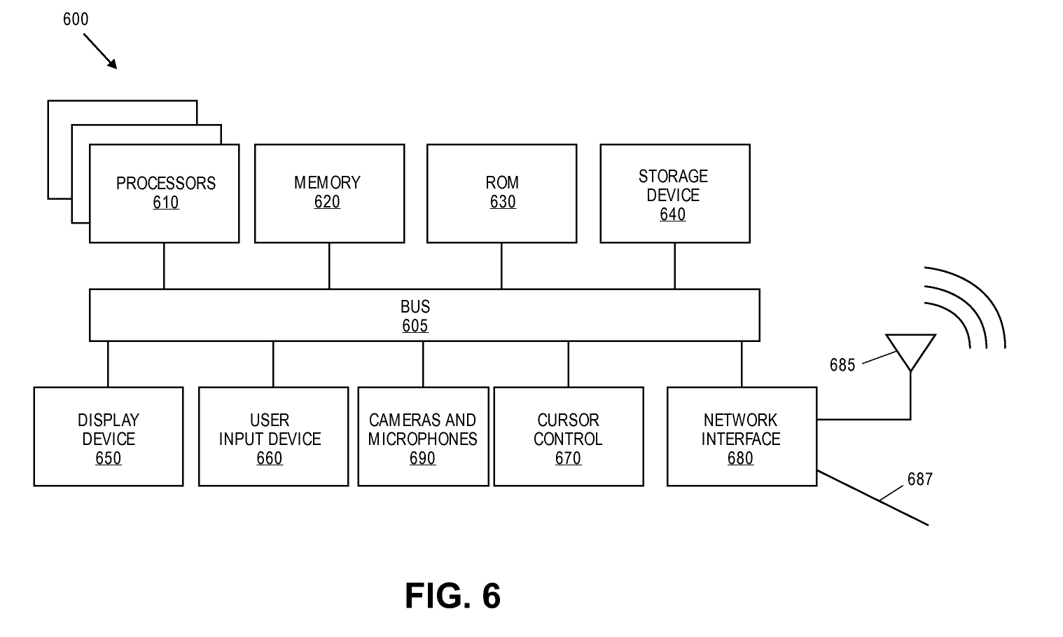

FIG. 6 illustrates an embodiment of a computing system 600. Computing system 600 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components.

Computing system 600 includes bus 605 (or a link, an interconnect, or another type of communication device or interface to communicate information) and processor 610 coupled to bus 605 that may process information. While computing system 600 is illustrated with a single processor, electronic system 600 and may include multiple processors and/or co-processors, such as one or more of central processors, graphics processors, and physics processors, etc. Computing system 600 may further include random access memory (RAM) or other dynamic storage device 620 (referred to as main memory), coupled to bus 605 and may store information and instructions that may be executed by processor 610. Main memory 620 may also be used to store temporary variables or other intermediate information during execution of instructions by processor 610.

Computing system 600 may also include read only memory (ROM) and/or other storage device 630 coupled to bus 605 that may store static information and instructions for processor 610. Date storage device 640 may be coupled to bus 605 to store information and instructions. Date storage device 640, such as magnetic disk or optical disc and corresponding drive may be coupled to computing system 600.

Computing system 600 may also be coupled via bus 605 to display device 650, such as a cathode ray tube (CRT), liquid crystal display (LCD) or Organic Light Emitting Diode (OLED) array, to display information to a user. User input device 660, including alphanumeric and other keys, may be coupled to bus 605 to communicate information and command selections to processor 610. Another type of user input device 660 is cursor control 670, such as a mouse, a trackball, or cursor direction keys to communicate direction information and command selections to processor 610 and to control cursor movement on display 650. Camera and microphone arrays 690 of computer system 600 may be coupled to bus 605 to observe gestures, record audio and video and to receive and transmit visual and audio commands.

Computing system 600 may further include network interface(s) 680 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 680 may include, for example, a wireless network interface having antenna 685, which may represent one or more antenna(e). Network interface(s) 680 may also include, for example, a wired network interface to communicate with remote devices via network cable 687, which may be, for example, an Ethernet cable, a coaxial cable, a fiber optic cable, a serial cable, or a parallel cable.

Network interface(s) 680 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 680 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 680 may including one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 600 may vary from implementation to implementation depending upon numerous factors, such as price constraints, performance requirements, technological improvements, or other circumstances. Examples of the electronic device or computer system 600 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Some embodiments pertain to a method comprising: evaluating, at a computing device, context-aware data collected via one or more sensor of a vehicle; recommending a context-aware advertisement based the evaluation of the context-aware data; and facilitating broadcasting of the recommended context-aware advertisement on a radio of the vehicle.

Embodiments or examples include any of the above methods further comprising data evaluating, via data management logic, context-aware data; and recommending, via advertisement recommendation logic, a context-aware advertisement based the evaluation of the context-aware data, and wherein the recommended context-aware advertisement is placed via at least one of a radio of a vehicle or a computing device within a proximity of the vehicle, wherein the computing device includes a mobile computing device.

Embodiments or examples include any of the above methods wherein the context-aware data comprises at least one of real-time context information relating to the vehicle, surrounding environment, and one or more individuals within the vehicle.

Embodiments or examples include any of the above methods further comprising evaluating, via the data management logic, an external advertisement image captured by one or more cameras, wherein the one or more cameras include a first camera of the vehicle, and eye movement tracking data captured by a second camera of the vehicle.

Embodiments or examples include any of the above methods further comprising recommending, via the advertisement and recommendation logic, an external advertisement to be virtually displayed on a portion of a windshield of the vehicle.

In another embodiment or example including a method, the method comprising: sensing, via one or more sensors, context-aware data, wherein the one or more sensors reside at a vehicle; collecting, via a data collection module, the context-aware data from the one or more sensors; receiving, via a recommendation reception and evaluation module, a recommendation to place a context-aware advertisement based an evaluation of the context-aware data; and facilitating broadcasting, via an advertisement placement module, of the recommended context-aware advertisement via at least one of a radio of the vehicle or a computing device within a proximity of the vehicle, wherein the computing device includes a mobile computing device.

Embodiments or examples include any of the above methods further comprising: receiving, via a broadcast link module, a broadcast stream from a broadcast station, the broadcast stream having a signal indicating details to replace one or more broadcast advertisements with the recommended context-aware advertisement, and replacing, via the advertisement placement module, the one or more broadcast advertisements with the recommended context aware advertisements; and facilitating storing, via the advertisement placement module, the recommended context-aware advertisement at a persistent local storage of the vehicle, wherein statistics about a variety of impressions relating to the stored context-aware advertisements are collected and stored at the persistent storage or updated to the broadcast station for future use, wherein the future use includes adjusting future recommended or broadcasted advertisements according to the statistics.

Embodiments or examples include any of the above methods wherein the one or more sensors comprise one or more of a global positioning system (GPS) device, a brake sensor, a rain sensor, a fuel sensor, a temperature sensor, an oxygen sensor, a parking sensor, a compass, a speedometer, a clock, an on-board diagnostics (OBD) tool, and a Bluetooth pairing device.

Embodiments or examples include any of the above methods further comprising receiving, via the recommendation reception and evaluation module, a recommendation to virtually display an external advertisement on a windshield of the vehicle; and facilitating, via a projection system at the vehicle, the virtual display of the recommended external advertisement on a selected portion of the windshield of the vehicle.

Embodiments or examples include any of the above methods further comprising: capturing, via a first camera, the external advertisement from an external source, wherein the first camera includes a forward facing camera, and wherein the external source includes a billboard; and tracking, via a second camera, eye movement of eyes of an individual in the vehicle, and to note eye movement data resulting from tracking of the eye movement, wherein the second camera includes a rear facing camera.

Embodiments or examples include any of the above methods wherein the recommended external advertisement is virtually displayed on the portion of the windshield of the vehicle via a projection system of the vehicle.

Embodiments or examples include any of the above methods wherein the vehicle further comprises: a first camera to capture the external advertisement from an external source, wherein the first camera includes a forward facing camera, and wherein the external source includes a billboard; and a second camera to track eye movement of eyes of an individual in the vehicle, and to note eye movement data resulting from tracking of the eye movement, wherein the second camera includes a rear facing camera.

Embodiments or examples include any of the above methods wherein the context-aware data is received from the vehicle as sensed via one or more sensors at the vehicle, wherein the one or more sensors comprise one or more of a global positioning system (GPS) device, a brake sensor, a rain sensor, a fuel sensor, a temperature sensor, an oxygen sensor, a parking sensor, a compass, a speedometer, a clock, an on-board diagnostics (OBD) tool, and a Bluetooth pairing device.

Another embodiment or example includes an apparatus performing any of the methods in the examples above.

In another embodiment or example including an apparatus, the apparatus comprising: data management logic to evaluate context-aware data; and advertisement recommendation logic to recommend a context-aware advertisement based the evaluation of the context-aware data, and wherein the recommended context-aware advertisement is placed via at least one of a radio of a vehicle or a computing device within a proximity of the vehicle, wherein the computing device includes a mobile computing device.

Embodiments or examples include the apparatus above wherein the context-aware data comprises at least one of real-time context information relating to the vehicle, surrounding environment, and one or more individuals within the vehicle.

Embodiments or examples include the apparatus above wherein the data management logic is further to evaluate an external advertisement image captured by one or more cameras, wherein the one or more cameras include a first camera of the vehicle, and eye movement tracking data captured by a second camera of the vehicle.

Embodiments or examples include the apparatus above wherein the advertisement and recommendation logic is further to recommend an external advertisement to be virtually displayed on a portion of a windshield of the vehicle.

In another embodiment or example including an apparatus, the apparatus comprising: one or more sensors to sense context-aware data, wherein the one or more sensors reside at a vehicle; a data collection module to collect the context-aware data from the one or more sensors; a recommendation reception and evaluation module to receive a recommendation to place a context-aware advertisement based an evaluation of the context-aware data; and an advertisement placement module to facilitate broadcasting of the recommended context-aware advertisement via at least one of a radio of the vehicle or a computing device within a proximity of the vehicle, wherein the computing device includes a mobile computing device.

Embodiments or examples include the apparatus above further comprising: a broadcast link module to receive a broadcast stream from a broadcast station, the broadcast stream having a signal indicating details to replace one or more broadcast advertisements with the recommended context-aware advertisement, and wherein the advertisement placement module is further to replace the one or more broadcast advertisements with the recommended context aware advertisements; and wherein the advertisement placement module is further to store the recommended context-aware advertisement at a persistent local storage of the vehicle, wherein statistics about a variety of impressions relating to the stored context-aware advertisements are collected and stored at the persistent storage or updated to the broadcast station for future use, wherein the future use includes adjusting future recommended or broadcasted advertisements according to the statistics.

Embodiments or examples include the apparatus above wherein the one or more sensors comprise one or more of a global positioning system (GPS) device, a brake sensor, a rain sensor, a fuel sensor, a temperature sensor, an oxygen sensor, a parking sensor, a compass, a speedometer, a clock, an on-board diagnostics (OBD) tool, and a Bluetooth pairing device.

Embodiments or examples include the apparatus above wherein the recommendation reception and evaluation module is further to receive a recommendation to virtually display an external advertisement on a windshield of the vehicle, wherein the apparatus further comprising a projection system to virtually display the recommended external advertisement on a selected portion of the windshield of the vehicle.

Embodiments or examples include the apparatus above further comprising: a first camera to capture the external advertisement from an external source, wherein the first camera includes a forward facing camera, and wherein the external source includes a billboard; and a second camera to track eye movement of eyes of an individual in the vehicle, and to note eye movement data resulting from tracking of the eye movement, wherein the second camera includes a rear facing camera.

In another embodiment or example having a system, the system comprising: a computing device having a memory to store instructions, and a processing device to execute the instructions, the computing device further having a mechanism to: evaluate, via data management logic, context-aware data; and recommend, via advertisement recommendation logic, a context-aware advertisement based the evaluation of the context-aware data, and wherein the recommended context-aware advertisement is placed via at least one of a radio of a vehicle or a computing device within a proximity of the vehicle, wherein the computing device includes a mobile computing device.

Embodiments or examples include the system above wherein the context-aware data comprises at least one of real-time context information relating to the vehicle, surrounding environment, and one or more individuals within the vehicle.

Embodiments or examples include the system above wherein the mechanism is further to evaluate, via the data management logic, an external advertisement image captured by one or more cameras, wherein the one or more cameras include a first camera of the vehicle, and eye movement tracking data captured by a second camera of the vehicle.

Embodiments or examples include the system above wherein the mechanism is further to recommend, via the advertisement and recommendation logic, an external advertisement to be virtually displayed on a portion of a windshield of the vehicle.

In another embodiment or example having a system, the system comprising: a computing device having a memory to store instructions, and a processing device to execute the instructions, the computing device further having a mechanism to: sense, via one or more sensors, context-aware data, wherein the one or more sensors reside at a vehicle; collect, via a data collection module, the context-aware data from the one or more sensors; receive, via a recommendation reception and evaluation module, a recommendation to place a context-aware advertisement based an evaluation of the context-aware data; and facilitate broadcasting, via an advertisement placement module, of the recommended context-aware advertisement via at least one of a radio of the vehicle or a computing device within a proximity of the vehicle, wherein the computing device includes a mobile computing device.

Embodiments or examples include the system above wherein the mechanism is further to: receive, via a broadcast link module, a broadcast stream from a broadcast station, the broadcast stream having a signal indicating details to replace one or more broadcast advertisements with the recommended context-aware advertisement, and wherein the advertisement placement module is further to replace the one or more broadcast advertisements with the recommended context aware advertisements; and wherein the advertisement placement module is further to store the recommended context-aware advertisement at a persistent local storage of the vehicle, wherein statistics about a variety of impressions relating to the stored context-aware advertisements are collected and stored at the persistent storage or updated to the broadcast station for future use, wherein the future use includes adjusting future recommended or broadcasted advertisements according to the statistics.

Embodiments or examples include the system above wherein the one or more sensors comprise one or more of a global positioning system (GPS) device, a brake sensor, a rain sensor, a fuel sensor, a temperature sensor, an oxygen sensor, a parking sensor, a compass, a speedometer, a clock, an on-board diagnostics (OBD) tool, and a Bluetooth pairing device.

Embodiments or examples include the system above wherein the mechanism is further to receive, via the recommendation reception and evaluation module, a recommendation to virtually display an external advertisement on a windshield of the vehicle, wherein the apparatus further comprising a projection system to virtually display the recommended external advertisement on a selected portion of the windshield of the vehicle.

Embodiments or examples include the system above wherein the mechanism is further to: capture, via a first camera, the external advertisement from an external source, wherein the first camera includes a forward facing camera, and wherein the external source includes a billboard; and track, via a second camera, eye movement of eyes of an individual in the vehicle, and to note eye movement data resulting from tracking of the eye movement, wherein the second camera includes a rear facing camera.

In another embodiment or example, an apparatus comprises means for performing any one or more of the operations mentioned above.

In yet another embodiment or example, at least one machine-readable storage medium comprising a plurality of instructions that in response to being executed on a computing device, causes the computing device to carry out a method according to any one or more of the operations mentioned above.

In yet another embodiment or example, at least one non-transitory or tangible machine-readable storage medium comprising a plurality of instructions that in response to being executed on a computing device, causes the computing device to carry out a method according to any one or more of the operations mentioned above.

In yet another embodiment or example, a computing device arranged to perform a method according to any one or more of the operations mentioned above.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
data management logic to evaluate context-aware data; and
advertisement recommendation logic to recommend a context-aware advertisement based the evaluation of the context-aware data, and wherein the recommended context-aware advertisement is placed via at least one of a radio of a vehicle or a computing device within a proximity of the vehicle, wherein the computing device includes a mobile computing device.

2. The apparatus of claim 1, wherein the context-aware data comprises at least one of real-time context information relating to the vehicle, surrounding environment, and one or more individuals within the vehicle.

3. The apparatus of claim 1, wherein the data management logic is further to evaluate an external advertisement image captured by one or more cameras, wherein the one or more cameras include a first camera of the vehicle, and eye movement tracking data captured by a second camera of the vehicle.

4. The apparatus of claim 1, wherein the advertisement and recommendation logic is further to recommend an external advertisement to be virtually displayed on a portion of a windshield of the vehicle.

5. An apparatus comprising:
one or more sensors to sense context-aware data, wherein the one or more sensors reside at a vehicle;
a data collection module to collect the context-aware data from the one or more sensors;
a recommendation reception and evaluation module to receive a recommendation to place a context-aware advertisement based an evaluation of the context-aware data; and
an advertisement placement module to facilitate broadcasting of the recommended context-aware advertisement via at least one of a radio of the vehicle or a computing device within a proximity of the vehicle, wherein the computing device includes a mobile computing device.

6. The apparatus of claim 5, further comprising:
a broadcast link module to receive a broadcast stream from a broadcast station, the broadcast stream having a signal indicating details to replace one or more broadcast advertisements with the recommended context-aware advertisement, and wherein the advertisement placement module is further to replace the one or more broadcast advertisements with the recommended context aware advertisements; and
wherein the advertisement placement module is further to store the recommended context-aware advertisement at a persistent local storage of the vehicle, wherein statistics about a variety of impressions relating to the stored context-aware advertisements are collected and stored for future use, wherein the future use includes adjusting future recommended or broadcasted advertisements according to the statistics.

7. The apparatus of claim 5, wherein the one or more sensors comprise one or more of a global positioning system (GPS) device, a brake sensor, a rain sensor, a fuel sensor, a temperature sensor, an oxygen sensor, a parking sensor, a compass, a speedometer, a clock, an on-board diagnostics (OBD) tool, and a Bluetooth pairing device.

8. The apparatus of claims 5, wherein the recommendation reception and evaluation module is further to receive a recommendation to virtually display an external advertisement on a windshield of the vehicle, wherein the apparatus further comprising a projection system to virtually display the recommended external advertisement on a selected portion of the windshield of the vehicle.

9. The apparatus of claim 8, further comprising:
a first camera to capture the external advertisement from an external source, wherein the first camera includes a forward facing camera, and wherein the external source includes a billboard; and
a second camera to track eye movement of eyes of an individual in the vehicle, and to note eye movement data resulting from tracking of the eye movement, wherein the second camera includes a rear facing camera.

10. A system comprising:
a computing device having a memory to store instructions, and a processing device to execute the instructions, the computing device further having a mechanism to:
evaluate, via data management logic, context-aware data; and
recommend, via advertisement recommendation logic, a context-aware advertisement based the evaluation of the context-aware data, and wherein the recommended context-aware advertisement is placed via at least one of a radio of a vehicle or a computing device within a proximity of the vehicle, wherein the computing device includes a mobile computing device.

11. The system of claim 10, wherein the context-aware data comprises at least one of real-time context information relating to the vehicle, surrounding environment, and one or more individuals within the vehicle.

12. The system of claim 10, wherein the mechanism is further to evaluate, via the data management logic, an external advertisement image captured by one or more cameras, wherein the one or more cameras include a first camera of the vehicle, and eye movement tracking data captured by a second camera of the vehicle.

13. The system of claim 10, wherein the mechanism is further to recommend, via the advertisement and recommendation logic, an external advertisement to be virtually displayed on a portion of a windshield of the vehicle.

14. At least one machine-readable storage medium comprising a plurality of instructions that in response to being executed on a computing device, causes the computing device to carry out a method according to one or more operations comprising:
evaluating context-aware data; and
recommending a context-aware advertisement based the evaluation of the context-aware data, and wherein the recommended context-aware advertisement is placed via at least one of a radio of a vehicle or a computing device within a proximity of the vehicle, wherein the computing device includes a mobile computing device.

15. The machine-readable storage medium of claim 14, wherein the context-aware data comprises at least one of real-time context information relating to the vehicle, surrounding environment, and one or more individuals within the vehicle.

16. The machine-readable storage medium of claim 14, wherein the one or more operations further comprise: evaluating an external advertisement image captured by one or more cameras, wherein the one or more cameras include a first camera of the vehicle, and eye movement tracking data captured by a second camera of the vehicle.

17. The machine-readable storage medium of claim 14, wherein the one or more operations further comprise: recommending an external advertisement to be virtually displayed on a portion of a windshield of the vehicle.

18. The machine-readable storage medium of claim 17, wherein the recommended external advertisement is virtually displayed on the portion of the windshield of the vehicle via a projection system of the vehicle.

19. The machine-readable storage medium of claim 18, wherein the vehicle further comprises:
a first camera to capture the external advertisement from an external source, wherein the first camera includes a forward facing camera, and wherein the external source includes a billboard; and
a second camera to track eye movement of eyes of an individual in the vehicle, and to note eye movement data resulting from tracking of the eye movement, wherein the second camera includes a rear facing camera.

20. The machine-readable storage medium of claim 14, wherein the context-aware data is received from the vehicle as sensed via one or more sensors at the vehicle, wherein the one or more sensors comprise one or more of a global positioning system (GPS) device, a brake sensor, a rain sensor, a fuel sensor, a temperature sensor, an oxygen sensor, a parking sensor, a compass, a speedometer, a clock, an on-board diagnostics (OBD) tool, and a Bluetooth pairing device.
